(19) United States
(12) Patent Application Publication
(10) Pub. No.: US 2020/0317535 A1
(43) Pub. Date: Oct. 8, 2020

(54) METHOD AND APPARATUS FOR SODIUM CHLORIDE RECOVERY FROM A MIXED SALT STREAM

(71) Applicant: Aquatech International, LLC, Canonsburg, PA (US)

(72) Inventors: Daniel P. Bjorklund, Waukesha, WI (US); Gregory Mandigo, DeForest, WI (US); Garry D. Glover, Waukesha, WI (US); Manish Backliwal, Brookfield, WI (US); Lindsay C. Buhl, Hartland, WI (US)

(21) Appl. No.: 16/372,936

(22) Filed: Apr. 2, 2019

(51) Int. Cl. C01D 3/06

(52) U.S. Cl. CPC C01D 3/06

(57) ABSTRACT

A sodium chloride recovery method for upgrading a mixed salt stream from lower sodium chloride purity to an increased sodium chloride purity is provided. The salt recovery method utilizes the solubility properties of the impurities in the mixed salt to preferentially dissolve them over sodium chloride. As the impurities are removed from the solid phase using a salt stripper, sodium chloride rich slurry is generated. The rich salt slurry is processed by an upgrader to remove the remaining impurities. The upgraded sodium chloride slurry is dewatered and washed in the phase separator to generate sodium chloride salt at a higher purity.

### BACKGROUND

The United States is a heavy producer and consumer of salt. U.S. production of salt was estimated to be 43 million tons in 2017. In terms of salt production, the estimated percentage of salt that came from rock salt was 41%; salt in brine was 41%; solar salt was 9%; and vacuum pan salt was 9%. Highway deicing is the major salt consumer in the USA, totaling about 44% of total salt consumed. The chemical industry accounted for about 37% of total salt sales. Chlorine and caustic soda manufacturers were the main consumers within the chemical industry. This is as per the U.S. Geological Survey, Mineral Commodity Summaries January 2018.

The uses for sodium chloride directly correlate to its achieved purity. For road salt applications, the American Society for Testing and Materials defines purity standard specifications in designation D632-01. Road salt is required to have a sodium chloride purity >95%, with grades based on the size of the crystals. Additionally, some states specify elements that cannot be present in deicers. The standard purity for food grade sodium chloride is >97% (Codex Stan 150-1985), and higher purity salt (>99.9%) can be used in chlor-alkali processes.

As per the USA Salt Institute, the United States and China are the largest producers of salt in the world with their combined production accounting for 40% of the world's quarter billion tons of salt generated each year. Logistical considerations heavily influence production facility site selection decisions and these, in turn, heavily influence the size of production units and the structure of the salt industry.

For salt production, the prevailing method of generation is solar evaporation, which is also the least expensive technology available and is favorable in dry and windy climates. Vast quantities of rock salt are also extracted in large commercial mines. Additionally, chemical companies create an enormous amount of salt in the form of brine that never is crystallized into dry salt.

There is growing emphasis on water treatment of highly saline brines. Flue Gas Desulphurization, Coal Gasification, and various Oil and Gas production processes commonly generate a highly saline brine water that contains sodium chloride with other salts in a mixed salt solution. Examples of such oil and gas enhanced recoveries include steam and water flooding, steam-assisted gravity drainage, and hydraulic fracturing. Typically, these mixed salts are not removed from the brine streams to allow for beneficial uses. Instead, the saline water is commonly disposed by deepwell injection. However, as environmental regulations tighten globally and as companies become progressively more accountable, there is a growing emphasis on recycling the wastewaters. The recovery of water from saline water, in turn, leads to the generation of large quantities of mixed salts including, for example sodium chloride, calcium chloride, potassium chloride and magnesium chloride. As mixed salts they are not fit for use in the U.S. salt market, and they are disposed of in a landfill.

Mixed salt may be purified through a process comprising dissolution of the salt and recrystallization. Such processes work by first completely dissolving the mixed salt, which includes the sodium chloride as well as the impurities (e.g. other salts). The brine stream is then crystallized at specific temperatures and pressures to preferentially precipitate the sodium chloride at a high purity. Impurities remain soluble and are removed in a small purge stream, which is a waste stream that needs disposal. The salt crystals are then dewatered, washed and dried to recover the pure salt. [Refer to FIG. 6.]

This technology has at least the following disadvantages:
1) High water consumption required for 100% dissolution of the solid impure salt
2) High capital costs associated with the complex crystallizer
3) High operating costs associated with the energy required to drive the pure salt crystallizer
4) Purge stream consisting of soluble impurities which is removed from the process continuously and must be disposed
5) Large infrastructure and plant footprint

### BRIEF SUMMARY OF THE INVENTION

The improvement of the salt quality for beneficial reuse is the next progressive step in the pursuit of an environmentally neutral process. This is accomplished by upgrading the relatively impure, mixed salt which simultaneously eliminates a waste salt that would otherwise need to be disposed and creates a pure salt.

Embodiments of our invented salt recovery method may overcome one or more of the disadvantages of complete dissolution and recrystallization that would otherwise be necessary to purify sodium chloride from mixed salt for beneficial reuse. The mixed salt is typically in the sold phase. The multistep process utilizes the differing solubility properties of sodium chloride and the impurities present to preferentially dissolve the impurities. As a result, the process is able to upgrade a low sodium chloride purity salt to a high sodium chloride purity salt. This is done through the use of a Salt Stripper, Upgrader and a Phase Separator. The method and apparatus described has the following advantages over the complete dissolution and recrystallization process:
1) Lower water consumption. The process is not designed for 100% dissolution of the mixed-salt, so more salt can be treated with a lower volume of water.
2) Lower capital cost. The process does not require a complex crystallizer and associated costs.
3) Lower operating cost. The process does not require the energy needed to operate a crystallizer.
4) In comparison to a crystallizer, the process has less necessary adjacent equipment. As such it has a lower infrastructure and plant footprint.

### BRIEF DESCRIPTION OF THE DRAWINGS

FIG. 1: The salt recovery system utilizing the invented technology.

FIG. 2: A salt recovery system utilizing the invented technology, featuring one alternative water injection and upgrader overflow configuration. This configuration specializes in the treatment of inlet streams with sodium chloride purities less the 90%.

FIG. 3: Sodium chloride solubility curve as a function of the calcium chloride in solution. Initially, the soluble NaCl concentration is 26 mass %. As the calcium chloride is added to solution, the sodium chloride precipitates.

FIG. 4: Sodium chloride and calcium chloride solubility curves during the stabilization phase of the invented process operating at 132° F. As a mixed salt stream is added to the system, the dissolved sodium chloride concentration first increases sharply but is subsequently reduced to a very low level for continuous, steady-state operation. Controlled operation at the steady-state point allows the process to selectively remove calcium chloride from the solid phase (through dissolution) and simultaneously keep the sodium chloride salt in the solid phase for upgrading.

FIG. 5: A salt recovery method comprised of complete dissolution followed by recrystallization.

### DETAILED DESCRIPTION OF THE INVENTION

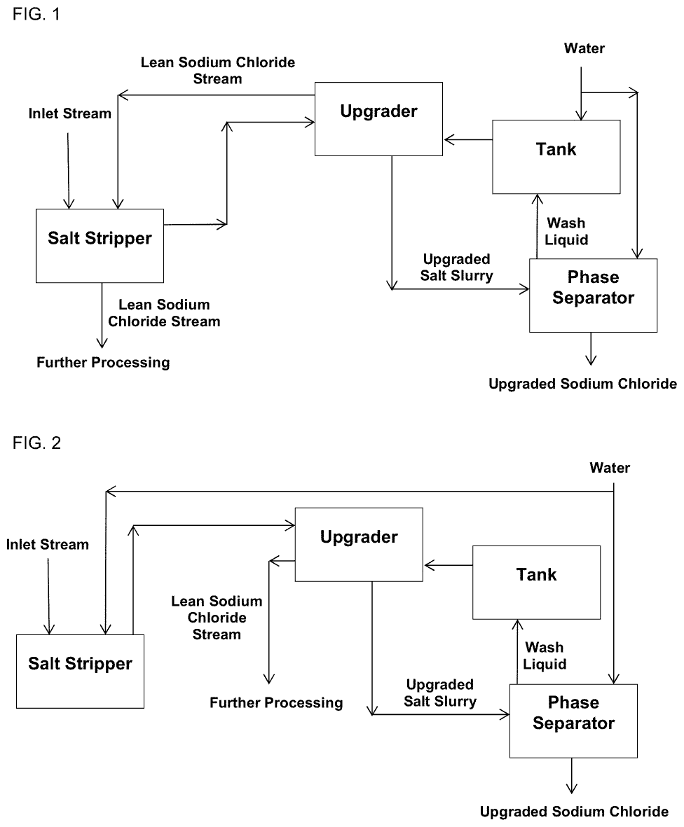

The invented sodium chloride recovery method comprises three key pieces of equipment: a salt stripper, an upgrader and a phase separator. Refer to FIG. 1 and FIG. 2 for diagrams of the invented salt recovery method.

The process takes advantage of the solubility properties of the salts found in many mixed salt streams to produce a pure sodium chloride salt. A number of salts are more soluble than sodium chloride and cause the solubility of sodium chloride to be suppressed as a result of the Common Ion Effect. These impurities can include: calcium chloride, magnesium chloride, barium chloride, potassium chloride and strontium chloride.

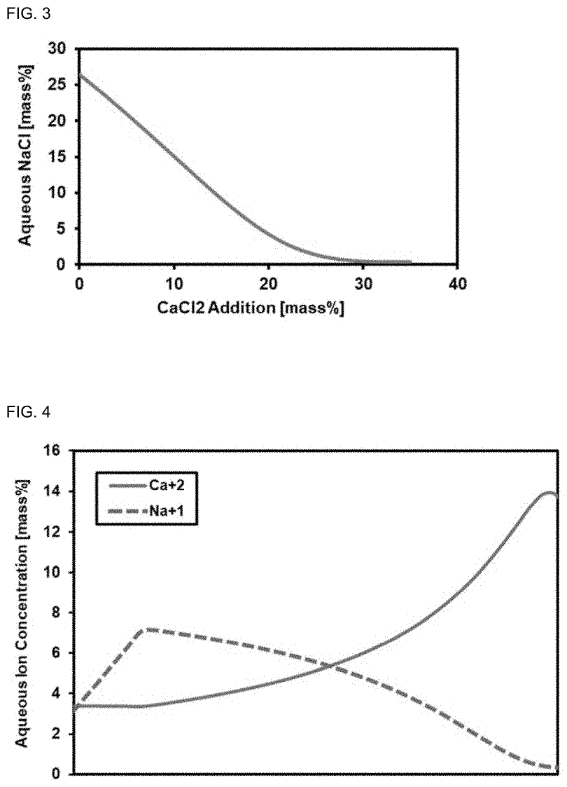

As per Le Châtelier's Principle, when one of the highly soluble impurities dissociate in solution, the relatively less soluble sodium chloride increases in association. Refer to FIG. 3, in which the addition of calcium chloride to a sodium chloride solution results in the precipitation of sodium chloride. As opposed to recrystallization, our salt recovery method does not fully dissolve all of the salts added to the process; the Salt Stripper allows salts with a greater solubility than sodium chloride to remain in solution while sodium chloride remains relatively insoluble. FIG. 3 and FIG. 4 represent the dissolution chemistry of sodium chloride in the presence of more soluble common ions. This principle is used throughout the salt recovery method reported herein.

In an initial step of the sodium chloride recovery process, a solid mixed salt is loaded into the Salt Stripper. There, the insoluble sodium chloride, as well as some soluble salts, settles to the bottom of the salt stripper. The underflow of the salt stripper, a rich sodium chloride stream, is then sent to the upgrader. The overflow of the salt stripper, containing soluble non-settling particles, is removed from the sodium chloride recovery apparatus and sent to further processing. This overflow is now rich in the highly soluble impurities.

Typically the salt stripper is a mixing tank. It can contain a mechanical agitator and a hydro educator to induce mixing. Additionally, the internal baffling within the tank could promote mixing while a surface trough allows for the separation and collection of overflow containing the highly soluble impurities.

In the upgrader, the principles described by Stoke's Law are used to perform elutriation on the rich sodium chloride stream. Stoke's Law expresses the frictional or drag forces versus the gravitational forces experienced by small particles within fluids. In elutriation, particles in a high impurity stream are separated by their differing size, shape and density, using a stream of low impurity liquid, that is, liquid not containing a concentration of non-NaCl salts that is high relative to the rich sodium chloride stream, flowing in a direction opposite (countercurrent) to the direction of sedimentation. The countercurrent low impurity stream washes the sodium chloride, further preferentially dissolving any non-NaCl salt impurities. Then, the low impurity stream flows such that it is able to overcome the settling velocity of any undissolved impurities and carries them to the overflow of the upgrader. The low impurity stream is the lean sodium chloride stream that leaves the top of the upgrader.

Typically an upgrader is a vertical column.

Based on the concentration of the impurities present in the lean sodium chloride stream, the overflow of the upgrader can be recycled back into the process, such as to the salt stripper, or removed for further processing separate from the salt stripper and the upgrader. The heavier, insoluble sodium chloride has a settling velocity sufficient to overcome the countercurrent flow and settles to the underflow of the upgrader. The upgraded (that is, more pure) salt slurry from the underflow of the upgrader is sent to a phase separator.

A phase separator is used to separate the solid sodium chloride crystals from the water and any remaining soluble salts with a centrifuge, filter press or other dewatering device. In the case of a centrifuge, the liquid and the insoluble sodium chloride are separated as a result of centrifugal forces which cause the phases to separate based on their differing densities. In a pusher centrifuge, this allows the sodium chloride to separate from its carrying liquid and then be further washed with clean water. This washing dissolves the remaining impurities on the sodium chloride before delivering the final, dry salt. The dewatering device could also constitute a filter press, in which pressure is used to separate the carrying liquid and the solid sodium chloride. The upgraded salt slurry is loaded into the filter press. Once closed, the filter press plates do not move but the slurry pump causes the pressure to build. As pressure builds, the liquid is squeezed through the filters, which do not allow any solids to pass through. This leaves behind a dry cake of sodium chloride.

In further embodiments the liquid removed from and used to wash the solid sodium chloride the dewatering device is sent to a tank. There, it may be mixed with clean water before returning to the upgrader. In the upgrader, it creates the low impurity countercurrent flow opposing sedimentation that carries the soluble salts to the overflow of the vessel.

In summary, the salt recovery reported herein is able to separate and purify sodium chloride from a mixed salt stream. The method utilizes no intense thermal processes and can be performed at ambient temperatures, allowing this separation to operate in a more cost effective manner than in typical recrystallization systems.

Embodiments herein have been discussed in the context of removal and purification of sodium chloride salts. One skilled in the art will, however, recognize that the methods and systems could also be effective when purifying any mixed salt stream that includes salts of varying solubilities.

### EXAMPLES

To highlight the advantages of utilizing the sodium chloride recovery method and apparatus, examples of its use are presented. As stated previously, the invented technology could be incorporated in industries from a list that includes, for example, but is not limited to: Flue Gas Desulphurization, Coal Gasification, Oil and Gas production by enhanced oil recoveries such as steam and water flooding, Steam-Assisted Gravity Drainage, Coal Seam Gas, Fracking, and others. The following examples showcase the Hydraulic Fracturing and Flue Gas Desulphurization industries.

### Example 1: Utilization in Hydraulic Fracturing

Hydraulic fracturing is one area of application for the salt recovery method as reported herein. To control the type of breakage and complex fracturing necessary for the separation of tight underground shale formations, the injection water is treated to ensure it has the correct viscosity and density. As a result of the complex chemistry associated with fresh fracking liquid, produced water is unsuitable for direct reuse as it has extremely high sodium chloride content. When the injected fluid breaks the shale, the fluid leaches salt from the underground geological formations. The high concentration of salt in the stream, as well as other leached metals present, make the produced water toxic compared to surface water.

Hydraulic fracturing facilities typically dispose of their produced water in three ways.
1) Fracking sites inject the produced water in deep wells. However, many sites have regulations prohibiting this method citing alleged environmental contamination and geological limitations.
2) The produced water can be transported to a wastewater treatment site that is able to handle the quantity and chemistry. Unfortunately, many small-town municipal treatment systems located near fracking sites are not able to meet the high volume demands or manage the high total dissolved solids content.
3) The produced water is fully or partially treated on site. Areas with on-site treatment are able to reuse some of the water in further hydraulic fracking. The full treatment of the produced water involves recovery of large portion of the water and production of a mixed salt stream along with a purge which contains other impurities which are difficult to crystallize in the mixed salt.

Consider an embodiment of this technology in which the salt recovery system includes 1) two salt strippers, 2) two upgraders, 3) two phase separators, 4) and two tanks. The invented method will be utilized to concurrently upgrade two mixed salts containing sodium chloride.

In this embodiment, two salt streams from a hydraulic fracturing facility are sent to the salt recovery process. As stated previously, hydraulic fracturing generates high salinity produced water as a result of leaching in underground shale formations. In this example, the main components present in the leached water are sodium chloride and calcium chloride, typically in 70/30 ratio. The generated produced water has been partially pretreated onsite by conventional water treatment methods to create two distinct streams of solid salt. In the first salt stream (referred to as the High Calcium Salt), the sodium chloride content is greater than 50%. In the second salt stream (referred to as the Low Calcium Salt), the sodium chloride content is greater than 90%.

In this example, 25 tons per hour the High Calcium Salt (HC Salt) is fed into the salt stripper. The HC Salt has a sodium chloride content greater than 50%. In this case, recovered water or distillate from an alternative process at the hydraulic fracturing site is introduced to the Salt Stripper. Refer to FIG. 2. The Salt Stripper is designed to allow salts with a greater solubility than sodium chloride to remain in solution while sodium chloride remains relatively insoluble. The presence of other highly soluble salts reduces the solubility of sodium chloride as a result of the Common Ion Effect. Refer to the following solubility curves, FIG. 3 and FIG. 4. The insoluble sodium chloride and some soluble salts settle to the bottom of the salt stripper and are then sent to the upgrader. At this point, the sodium chloride content in the solid phase is generally greater than 95%.

In the upgrader, particles in a high impurity stream are separated by their differing size, shape and density, using a stream of low impurity liquid flowing in a direction opposite to the direction of sedimentation. The heavier, insoluble sodium chloride flows out the underflow of the upgrader while the countercurrent low impurity stream carries the soluble impurities to the overflow. For the HC Salt, the overflow of the upgrader is sent to further processing. Refer to FIG. 2. In this example, this reject stream is equal to 58 tons per hour and contains calcium chloride. The upgraded salt slurry from the underflow of the upgrader is sent to a phase separator.

The phase separator, which is this example is a pusher-type centrifuge, is used to separate the solid sodium chloride crystals from the water and any remaining soluble salts. Recovered water is added to the phase separator to further wash the salt. Both the upgraded sodium chloride and the wash liquid exit the phase separator. The wash liquid is sent to a tank before returning to the upgrader. Here, it creates the countercurrent flow opposing sedimentation that carries the soluble salts to the overflow of the upgrader. 5 tons per hour of upgraded sodium chloride is produced from HC Salt. It now has a purity of greater than 95%, allowing the upgraded salt to be sold as road salt.

Preparation of road salt by embodiments as reported herein can allow an operator to realize substantial savings. The current price for road salt is $45 per ton. Thus the total revenue, in this case, generated by the salt recovery process is $225 per hour.

The revenue for the process is calculated as follows:

(5 tons per hour)*($45 per ton)=$225 per hour

The cost to treat the brine wastewater from the example by others is $5.5 per ton. The estimated utility usage in this model is 50 kW per hour. Additionally, the utilities are $0.07/kW. In this case, the water added to the salt stripper and the phase separators is a distillate produced by alternative processes at the hydraulic fracturing site. As such it is not included in the operating cost.

The cost for the process is calculated as follows:

Brine Treatment is (58 tons/hr)*($5.5 per ton)=$319 per hour

Utilities is (50 kW per hour)*($0.07 per kW)=$3.5 per hour

The total cost is ($319 per hour)+($3.5 per hour)=$322.5 per hour

The cost of the salt recovery system is calculated as follows:

($225 per hour)−($322.5 per hour)=$97.5 per hour

For comparison, we will contrast this amount to the cost to treat HC Salt and LC Salt via a third party. The cost of disposing solid LC Salt and HC Salt is $50/ton.

The costs for treating the unprocessed streams are calculated as follows:

HC Salt is (25 tons per hour)*($50 per ton)=$1,250 per hour

To quantify the results of this example, the invented technology reduced the expense of HC Salt disposal by 92%. Given a year of continuous operation (8760 hours of operation) this would save the hydraulic fracturing facility $10 million annually.

Additionally, the salt recovery method reported is utilized to upgrade the Low Calcium Salt (LC Salt), with a sodium chloride content greater than 90%. 10 tons per hour of the LC Salt is introduced to the second salt stripper. Again, in the salt stripper, the solubility of the sodium chloride is controlled and the heavier insoluble salts are sent via the underflow to the upgrader. With the LC Salt inlet composition, 3.9 tons per hour of overflow of the salt stripper is sent to further processing. Additionally, for a LC Salt quality stream, water is not added directly to the salt stripper. Refer to FIG. 1.

The insoluble sodium chloride from the underflow of the upgrader is sent to the phase separator, a pusher-type centrifuge, for washing and solids removal. The wash liquid is sent to a tank before being returned to the upgrader as the countercurrent wash stream. The overflow of the upgrader containing the light insoluble impurities removed from the upgraded salt slurry is returned to the salt stripper. The final upgraded solid sodium chloride exiting the phase separator consists of a purity of equal to or greater than 95%. At this purity the sodium chloride may be sold as road salt. At this point, 9.5 tons per hour of road salt is produced from the salt recovery processes.

The revenue for the process is calculated as follows:

(9.5 tons per hour)*($45 per ton)=$427.5 per hour

The cost to treat the brine wastewater from the example by others is $5.5 per ton. The estimated utility usage in this model is 35 kW per hour. Additionally, the utilities are $0.07/kW. In this case, the water added to the salt stripper and the phase separators is a distillate produced by alternative processes at the hydraulic fracturing site. As such it is not included in the operating cost.

The cost for the process is calculated as follows:

Brine Treatment is (3.9 tons/hr)*($5.5 per ton)=$21.5 per hour

Utilities is (35 kW per hour)*($0.07 per kW)=$2.5 per hour

The total cost is ($21.5 per hour)+($2.5 per hour)=$24 per hour

The profit from the salt recovery system is calculated as follows:

($427.5 per hour)−($24 per hour)=$403.5 per hour

The costs for treating the unprocessed streams are calculated as follows:

LC Salt is (10 tons per hour)*($50 per ton)=$500 per hour

To quantify the results of this example, the technology as reported herein turned what was a $500 per hour expense into a $403.5 per hour profit. Given a year of continuous operation (8760 hours of operation) the invented salt recovery method would generate roughly $3.5 million per year. Previously, the cost for a year of continuous operation was $4.4 million.

In the original premise of this example, the fracking site concurrently produced the two streams. By combining the costs and revenue from the LC Salt and the HC Salt, the salt recovery method generates a profit of roughly $2.6 million. This is opposed to a yearly cost of $15.3 million. This difference represents a $17.9 million increase in annual spending potential.

### Example 2: Utilization in Flue Gas Desulphurization

In coal fired power plants, the flue gas contains compounds such as SOx and NOx. These compounds are harmful to both the atmosphere and the surrounding community. As such, air quality legislation has led to an increase in power plants utilizing flue gas desulphurization (FGD). FGD strips these harmful compounds before the flue gas is discharged to the atmosphere.

Approximately 85% of FGD systems in the USA are wet scrubber systems, which utilize a large volume of water. This water, containing a lime sorbent, is sprayed into the flue gas scrubber where the harmful compounds dissolve into the slurry droplets and react with the lime. The water falls to the bottom and continuously circulates the scrubber. A partial blowdown is taken to keep the chloride levels constant in the circulating water. The blowdown from the FGD system must be treated before being released to surface water. FGD wastewater poses a challenge to treat because of the following unique characteristics:
1) High concentrations of the total dissolved solids (TDS) and the total suspended solids (TSS) in the waste stream
2) Supersaturation in sulfates
3) Ammonia, and miscellaneous heavy metals and trace constituents (i.e., arsenic, mercury, selenium, boron, etc.) present that vary by coal type

Due to the highly complex nature of FGD wastewater, several stages are required to treat wastewater blowdown from the FGD scrubber to meet surface water discharge requirements. This treatment typically includes the following steps:
1) Calcium sulfate removal
2) Softening system which also includes trace metals precipitation
3) Evaporation and crystallization system to achieve Zero Liquid Discharge

From the crystallization, the salt produced is the mixed salt which contains a mixture of NaCl, CaCl₂ and MgCl₂ salts.

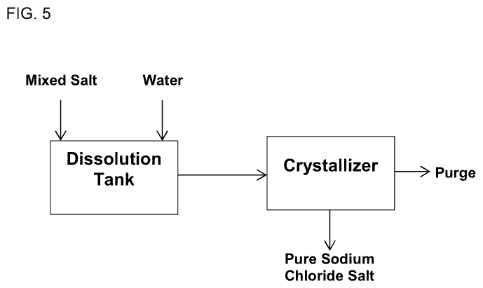

In this embodiment, a high salt stream from a flue gas desulphurization (FGD) system is added to the salt recovery process. The stream has been pretreated by conventional water treatment methods, shown in FIG. 5, to create a solid stream containing sodium chloride, calcium chloride, magnesium chloride and other trace impurities. The sodium chloride content is greater than 90%.

Consider an embodiment of this technology in which the salt recovery system includes 1) a salt stripper, 2) an upgrader, 3) a phase separator, 4) and a tank. Refer to FIG. 1. The invented method is utilized to upgrade the mixed salt containing sodium chloride to a pure sodium chloride stream.

Historically, the mixed salt would be sent to a landfill for disposal. In this example, the volume of mixed salt being sent to disposal is 2.0 tons per hour. Given the same disposal fee of $50 per ton, disposal of the mixed salt would cost $100 per hour.

The cost for treating the unprocessed mixed salt is calculated as follows:

Mixed Salt Disposal (2.0 tons per hour)*($50 per ton)=$100 per hour

However, utilizing the salt recovery process reported herein, a mixed salt solid can be used to generate 1.9 tons per hour of road salt quality sodium chloride. The mixed salt undergoes the same processes as described for the LC Salt quality stream in the hydraulic fracturing example. Refer to FIG. 1. At the current price for road salt, $45 per ton, that would generate $85.5 per hour.

Revenue generated from invented processes is calculated as follows:

(1.9 tons per hour)*($45 per ton)=$85.5 per hour

The invented salt process would require water, which is generated in the conventional water treatment process for FGD. Additionally the process would require a power utility estimated at 25 kW per hour at $0.07/kW. This example generates 0.8 tons per hour of brine.

The cost for the process is calculated as follows:

Brine Treatment is (0.8 tons per hour)*($5.5 per ton)=$4.4 per hour

Power Utilities is (25 kW per hour)*($0.07/kW)=$1.8 per hour

The total cost is ($4.4 per hour)+($1.8 per hour)=$6.2 per hour

The operating cost advantage from the salt recovery system is calculated as follows:

($85.5 per hour)−($6.2 per hour)=$79.3 per hour

To quantify the results of this example, the invented technology turns what was a $100 per hour cost into a $79.3 per hour profit. Given a year of continuous operation the invented salt recovery method would generate roughly $695,000. Previously, the cost for a year of continuous operation was $876,000. This is a beneficial difference of $1.57 million as it converts an operating cost to a saleable product.

1. A method of sodium chloride purification from a mixed aqueous salt stream, comprising:
a) providing a mixed salt stream comprising sodium chloride and at least one additional salt impurity;
b) removing the salt impurity from an impure sodium chloride solid stream in a salt stripper, to produce a sodium chloride salt slurry;
c) elutriating sodium chloride from the sodium chloride salt slurry in an upgrader to produce a high concentration sodium chloride salt slurry and a low concentration sodium chloride salt slurry;
d) dewatering the high concentration sodium salt slurry in a phase separator to produce upgraded sodium chloride salt;
e) washing the sodium chloride salt in the phase separator with water;
f) recovering the upgraded sodium chloride salt from the phase separator;
g) collecting a wash liquid from the phase separator in a tank;
h) sending the wash liquid from the tank to the upgrader;
i) returning an overflow from the upgrader to the salt stripper;
j) collecting an overflow of the salt stripper in a storage tank.

2. The method of claim 1, in which a salt concentration in the aqueous mixed salt stream is a majority of sodium chloride salt.

3. The method of claim 1, in which of the at least one additional salt impurity comprises at least one salt or other compound more soluble than sodium chloride.

4. The method of claim 3, in which the at least one additional salt impurity comprises at least one member selected from the group consisting of calcium chloride, magnesium chloride, barium chloride, potassium chloride and strontium chloride.

5. The method of claim 1, where the salt stripper consists of a vessel that preferentially solubilizes the at least one additional salt impurity and strips the at least one additional salt impurity from a solid sodium chloride phase.

6. The method of claim 5, further comprising treating the high concentration sodium chloride salt slurry with at least one additional water treatment process prior to its introduction to the upgrader.

7. The method of claim 6, wherein the at least one additional water treatment process is selected from the group consisting of lime softening, soda ash softening, caustic softening, sodium sulfate treatment, and precipitation.

8. The method of claim 1, where the upgrader comprises a vessel in which a salt stripper underflow flows countercurrent to a washing stream.

9. The method of claim 1, where the phase separator comprises a vessel in which solid sodium chloride from the underflow of the upgrader is separated from a liquid phase.

10. The method of claim 9, in which the phase separator comprises at least one member of the group consisting of a plate and frame filter press, a belt filter press, a centrifuge, and a vacuum filter.

11. The method of claim 1, further comprising adding water to at least one of the upgrader, the salt stripper, and the tank.

12. The method of claim 1, wherein overflow from the upgrader is not sent to the salt stripper.

13. The method of claim 1, further comprising taking the lean sodium chloride stream from overflow of the salt stripper or upgrader directly for reuse or further processing.

14. The method of claim 1, further comprising heating or cooling the water stream.

15. A method of purification of a selected salt from a mixed salt stream, comprising:
a) providing a mixed salt stream comprising a selected salt and at least one additional salt impurity, wherein the additional salt salt impurity is more soluble in water than the selected salt;
b) removing the salt impurity from an impure selected salt solid stream in a salt stripper, to produce a selected salt slurry;
c) elutriating the selected salt from the salt slurry in an upgrader to produce a high concentration selected salt slurry and a low concentration selected salt slurry;
d) dewatering the high concentration selected salt slurry in a phase separator to produce upgraded selected salt;
e) washing the selected salt in the phase separator with water;
f) recovering the upgraded selected salt from the phase separator;
g) collecting a wash liquid from the phase separator in a tank;
h) sending the wash liquid from the tank to the upgrader;
i) returning an overflow from the upgrader to the salt stripper;
j) collecting an overflow of the salt stripper in a storage tank.
